(19) United States
(12) Patent Application Publication
(10) Pub. No.: US 2025/0233278 A1
(43) Pub. Date: Jul. 17, 2025

(54) CONDUCTIVE MODULE

(71) Applicant: YAZAKI CORPORATION, Tokyo (JP)

(72) Inventors: Katsunori Sato, Makinohara-shi, Shizuoka (JP); Tatsuya Oga, Makinohara-shi (JP); Mariko Nakagawa, Makinohara-shi (JP); Masato Tanaka, Makinohara-shi (JP)

(21) Appl. No.: 18/984,904

(22) Filed: Dec. 17, 2024

(30) Foreign Application Priority Data
Jan. 16, 2024 (JP) 2024-004817

(51) Int. Cl. H01M 50/507; H01M 10/42

(52) U.S. Cl. CPC H01M 50/507; H01M 10/425; H01M 2010/4271

(57) ABSTRACT

A conductive module includes a bus bar physically and electrically connected to an electrode terminal of one or a pair of battery cells of a battery module in which a plurality of the battery cells is arranged, a first circuit conductor that transmits battery state information of each of the battery cells to a battery monitoring device, a second circuit conductor that is responsible for transmission and reception of a signal between the battery monitoring device and a battery management device that performs battery management control on the battery module, a first connector that is connector-connected to the battery monitoring device to transmit the battery state information from the first circuit conductor to the battery monitoring device, and a second connector that is connector-connected to the battery management device to transmit and receive a signal.

### CROSS-REFERENCE TO RELATED APPLICATION(S)

The present application claims priority to and incorporates by reference the entire contents of Japanese Patent Application No. 2024-004817 filed in Japan on Jan. 16, 2024.

### BACKGROUND OF THE INVENTION

### 1. Field of the Invention

The present invention relates to a conductive module.

### 2. Description of the Related Art

Conventionally, a battery pack includes a battery module in which a plurality of battery cells is arranged, a battery management device that performs battery management control for ensuring safety of the battery module, a battery monitoring device that is assembled to the battery module and monitors a battery state of each battery cell, a conductive module assembled to the battery module, and a second circuit conductor such as an electric wire that is responsible for transmission and reception of a signal between the battery management device and the battery monitoring device. For example, the conductive module includes a bus bar that is physically and electrically connected to an electrode terminal of one or a pair of battery cells of the battery module, and a first circuit conductor that transmits battery state information of each battery cell to the battery monitoring device. The battery monitoring device calculates and determines a battery state based on a signal of the battery state information received from the first circuit conductor of the conductive module, and transmits a monitoring result of the battery state to the battery management device via the second circuit conductor. The battery management device performs charge/discharge control for each battery cell or calculates a state of charge (SOC) of each of the battery cells based on the monitoring result of the battery state received from the battery monitoring device. This type of battery pack is disclosed in, for example, Japanese Patent Application Laid-open No. JP 2023-95261 A.

Then, in a conventional battery pack, a first circuit conductor and a second circuit conductor are prepared as separate components. Therefore, the first circuit conductor is routed on a battery module by assembling a conductive module to the battery module. On the other hand, the second circuit conductor is routed and assembled to a battery management device through an individual routing path without being associated with the routing path of the first circuit conductor according to the installation place of the battery management device. As described above, in the conventional battery pack, in addition to an installation space for installing and fixing the conductive module on the battery module, a routing space for routing the second circuit conductor to the battery management device is required together with a fixing structure for fixing the second circuit conductor to the battery module or the like. Therefore, the conventional battery pack has room for improvement in reducing the size of the battery pack.

### SUMMARY OF THE INVENTION

An object of the present invention is to provide the conductive module capable of reducing the size of the battery pack.

In order to achieve the above mentioned object, a conductive module according to one aspect of the present invention includes a bus bar configured to be physically and electrically connected to an electrode terminal of one or a pair of battery cells of a battery module in which a plurality of the battery cells is arranged; a first circuit conductor configured to transmit battery state information of each of the battery cells to a battery monitoring device configured to monitor a battery state of each of the battery cells; a second circuit conductor configured to be responsible for transmission and reception of a signal between the battery monitoring device and a battery management device configured to perform battery management control on the battery module; a first connector configured to be connector-connected to the battery monitoring device to transmit the battery state information from the first circuit conductor to the battery monitoring device, and to transmit and receive a signal between the second circuit conductor and the battery monitoring device; and a second connector configured to be connector-connected to the battery management device to transmit and receive a signal between the second circuit conductor and the battery management device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view for explaining a conductive module according to an embodiment;

FIG. 2 is a plan view for explaining the conductive module according to the embodiment; and

FIG. 3 is a perspective view illustrating a battery module.

### DETAILED DESCRIPTION OF THE PREFERRED EMBODIMENTS

Hereinafter, an embodiment of a conductive module according to the present invention will be described in detail with reference to the drawings. Note that, the present invention is not limited by the embodiment.

### Embodiment

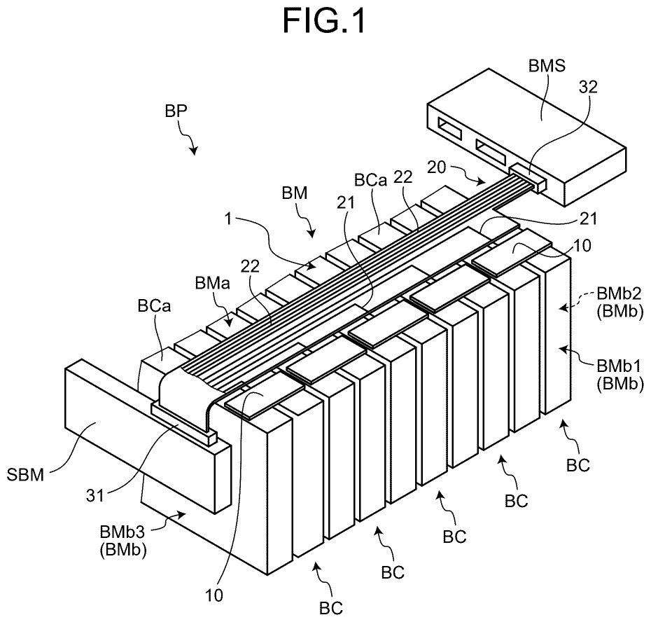

One of embodiments of a conductive module according to the present invention will be described with reference to FIGS. 1 to 3.

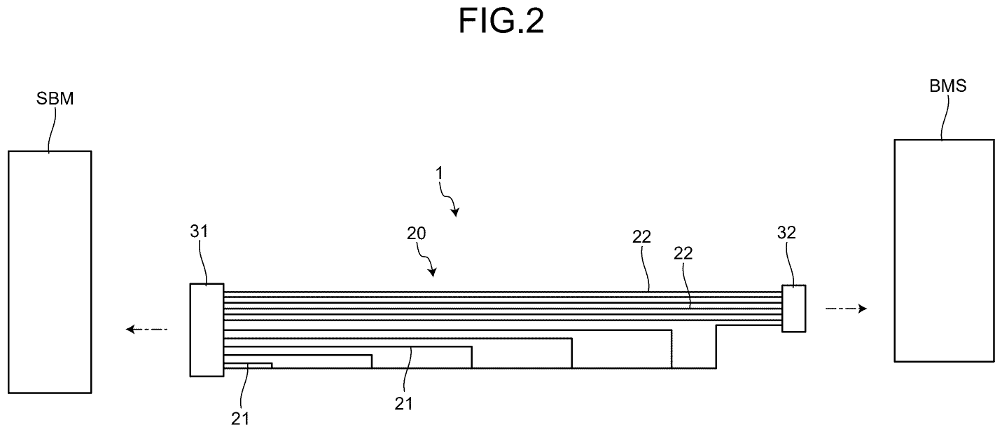

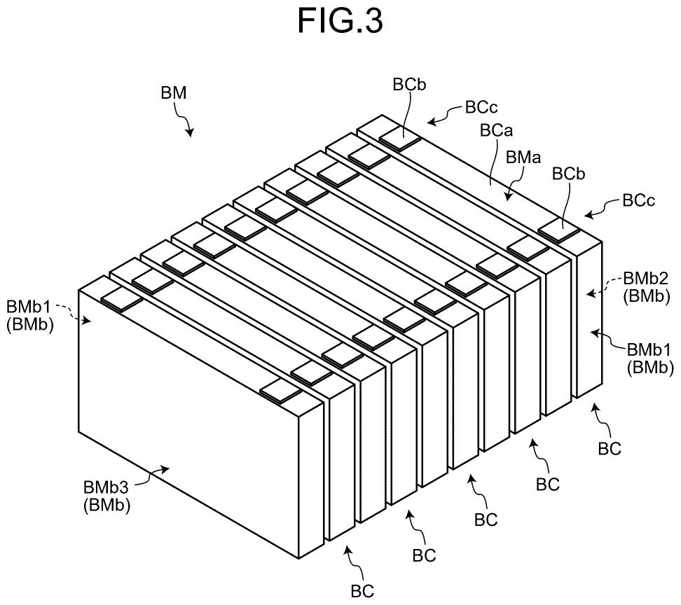

Reference sign 1 in FIGS. 1 and 2 denotes the conductive module of the present embodiment. The conductive module 1 is assembled to a battery module BM (FIG. 3) in which a plurality of battery cells BC is arranged (e.g., arranged in a single row).

The battery cell BC includes a cell body BCa and positive and negative electrode terminals BCb (FIG. 3). In the battery cell BC described here, the cell body BCa is formed in a rectangular parallelepiped shape having six outer wall surfaces. Then, in the plurality of battery cells BC included in the battery module BM, the cell bodies BCa adjacent to each other in the arrangement direction are arranged with one outer wall surface facing each other. The battery module BM includes one electrode terminal group BCc in which one electrode terminal BCb in each battery cell BC is arranged along the arrangement direction, and the other electrode terminal group BCc in which the other electrode terminal BCb in each battery cell BC is arranged along the arrangement direction.

In this example, each battery cell BC includes positive and negative electrode terminals BCb on one of the six outer wall surfaces of the cell body BCa (FIG. 3). Therefore, in the battery module BM, two electrode terminal groups BCc are provided on one plane (hereinafter, the surface is referred to as an “electrode installation surface”.) BMa (FIG. 3). Note that, in the battery module BM, four wall surfaces connected to intersect with the electrode installation surface BMa are referred to as outer peripheral wall surfaces BMb. Then, in the battery module BM, two of the four outer peripheral wall surfaces BMb arranged in parallel with each other are referred to as side wall surfaces BMb1. In addition, in the battery module BM, one of the remaining two of the four outer peripheral wall surfaces BMb arranged parallel to each other is referred to as a front wall surface BMb2, and the other is referred to as a rear wall surface BMb3.

Here, as the battery cell BC, although not illustrated, there is also known a battery cell in which the electrode terminal BCb of the positive electrode is provided on one outer wall surface of six outer wall surfaces of the cell body BCa, and the electrode terminal BCb of the negative electrode is provided on another one outer wall surface thereof. Then, in the battery module BM including such a battery cell BC, the electrode terminal groups BCc are provided on different planes. The plane is a portion referred to as a side wall surface BMb1 in the battery module BM exemplified above. The conductive module 1 of the present embodiment is also applied to such a battery module BM.

In addition, the electrode terminal BCb described here is formed in a flat plate shape, and physically and electrically connects a bus bar 10 to be described later in the conductive module 1 by welding or the like. However, the electrode terminal BCb may be formed in a pole shape having a male screw portion.

The battery module BM constitutes a battery pack BP by assembling the conductive module 1 and physically and electrically connecting the bus bar 10 to the electrode terminal BCb (FIG. 1). The battery pack BP is mounted on, for example, a vehicle (BEV: Battery Electric Vehicle, HEV: Hybrid Electric Vehicle, etc.) including a rotary machine as a drive source, and is used for power supply to the rotary machine. For example, the battery pack BP includes a plurality of battery modules BM.

In the battery pack BP, the conductive module 1 is caused to detect battery state information for monitoring the battery state of each battery cell BC, and a battery management device BMS (FIGS. 1 and 2) is caused to execute battery management control for the battery module BM based on the monitoring result of the battery state of each battery cell BC.

For example, in the small-capacity battery pack BP having a small number of battery modules BM, since the battery management device BMS is installed near the battery module BM, the conductive module is physically and electrically connected to the battery management device BMS. Therefore, the conventional battery management device BMS monitors the battery state of each battery cell BC based on the signal of the battery state information received from the conductive module, and performs the battery management control on the battery module BM based on the monitoring result.

However, in recent years, a large-capacity battery pack BP having a larger capacity than this is mounted on a vehicle. In the large-capacity battery pack BP, a battery monitoring device SBM (FIGS. 1 and 2) that monitors the battery state of each battery cell BC is interposed between the conductive module 1 and the battery management device BMS. In addition, in the large-capacity battery pack BP, the battery management device BMS is installed near some battery modules BM, and the battery management device BMS is installed at a position distant from some battery modules BM. The conductive module 1 of the present embodiment is applied to such a large-capacity battery pack BP (for example, the battery pack BP of a vehicle represented by a BEV or the like).

The battery management device BMS described herein is a main electronic control unit (ECU) of a battery management system that performs battery management control for ensuring safety of the battery module BM. The battery monitoring device SBM is a sub-ECU as a satellite battery module in the battery management system. The battery monitoring device SBM calculates and determines the battery state of each battery cell BC based on the signal of the battery state information received from the conductive module 1, and transmits the monitoring result of the battery state to the battery management device BMS. Based on the monitoring result of the battery state received from the battery monitoring device SBM, the battery management device BMS performs charge/discharge control (for example, charge/discharge control for preventing overcharge and over-discharge of the battery cell BC) on each battery cell BC, performs temperature management on each battery cell BC, and calculates a state of charge (SOC) of each battery cell BC.

The conductive module 1 constitutes the battery pack BP together with the battery module BM, the battery management device BMS, and the battery monitoring device SBM (FIG. 1). The battery pack BP includes the conductive module 1 and the battery monitoring device SBM for each battery module BM, and the battery monitoring device SBM for each battery module BM is connected to one battery management device BMS. The battery monitoring device SBM is assembled to the outer peripheral wall surface BMb (here, the rear wall surface BMb3) of the battery module BM, for example.

The conductive module 1 includes the bus bar 10 that is physically and electrically connected to the electrode terminal BCb of one or a pair of battery cells BC of the battery module BM (FIG. 1). The bus bar 10 is a plate-shaped conductive component made of metal, and is press-molded using, for example, a metal plate as a base material. The bus bar 10 described here is formed in a rectangular flat plate shape.

The conductive module 1 includes a first circuit conductor 21 that transmits battery state information of each battery cell BC to the battery monitoring device SBM, and a second circuit conductor 22 that is responsible for transmission and reception of a signal between the battery monitoring device SBM and the battery management device BMS (FIGS. 1 and 2). Then, the conductive module 1 includes a first connector 31 that is connector-connected to the battery monitoring device SBM to transmit battery state information from the first circuit conductor 21 to the battery monitoring device SBM and transmit and receive a signal between the second circuit conductor 22 and the battery monitoring device SBM, and a second connector 32 that is connector-connected to the battery management device BMS to transmit and receive a signal between the second circuit conductor 22 and the battery management device BMS (FIGS. 1 and 2).

In the conductive module 1, for example, a circuit conductor for voltage detection that electrically connects the bus bar 10 to the battery monitoring device SBM, a circuit conductor for temperature detection that is electrically connected to a thermistor that detects the temperature of the battery cell BC, and the like are provided as the first circuit conductor 21. The first circuit conductor 21 is provided for each bus bar 10. The former first circuit conductor 21 for voltage detection is physically and electrically connected to, for example, the bus bar 10 paired therewith via an electrical connection component (not illustrated, for example, a conductive component such as a terminal fitting or an electric wire).

The conductive module 1 is assembled to the electrode installation surface BMa of the battery module BM (FIG. 1). Then, in the conductive module 1, the bus bar 10 is physically and electrically connected to the electrode terminal BCb by laser welding or the like on the electrode installation surface BMa, and the first circuit conductor 21 and the second circuit conductor 22 are routed on the electrode installation surface BMa (FIG. 1). In the conductive module 1, the first circuit conductor 21 and the second circuit conductor 22 are routed to the outer peripheral wall surface BMb (here, rear wall surface BMb3) of the battery module BM, and the first connector 31 is connector-connected to the battery monitoring device SBM on the outer peripheral wall surface BMb (rear wall surface BMb3) (FIG. 1). In addition, in the conductive module 1, the second circuit conductor 22 is drawn out of the battery module BM beyond the electrode installation surface BMa and routed to the place of the battery management device BMS, and the second connector 32 is connector-connected to the battery management device BMS (FIG. 1).

Specifically, the conductive module 1 includes a circuit conductor component 20 provided with the first circuit conductor 21 and the second circuit conductor 22 (FIGS. 1 and 2). The first connector 31 and the second connector 32 are physically and electrically connected to the circuit conductor component 20. The conductive module 1 includes, for example, a holding member made of synthetic resin (not illustrated) that holds the bus bar 10 and the circuit conductor component 20 and is assembled to the battery module BM.

As the circuit conductor component 20, for example, a flexible printed circuit board (FPC) provided with a first conductor pattern as the first circuit conductor 21 and a second conductor pattern as the second circuit conductor 22 can be used. Here, the flexible printed circuit board is exemplified as the circuit conductor component 20 (FIGS. 1 and 2).

In addition, as the circuit conductor component 20, for example, a flexible flat cable (FFC) provided with a first core wire serving as the first circuit conductor 21 and a second core wire serving as the second circuit conductor 22 can be used.

In addition, in the circuit conductor component 20, an electric wire can be used as each of the first circuit conductor 21 and the second circuit conductor 22. In this case, in the circuit conductor component 20, the first connector 31 is physically and electrically connected to one end of each of the first circuit conductor 21 and the second circuit conductor 22, and the second connector 32 is physically and electrically connected to the other end of each of the first circuit conductor 21 and the second circuit conductor 22.

Note that, in a case where the conductive module 1 is assembled to the battery module BM placed at a position distant from the battery management device BMS, a conductor component (not illustrated) may be interposed between the second circuit conductor 22 and the second connector 32. In this case, the second circuit conductor 22 stops the routing path on the battery module BM and is not drawn out of the battery module BM beyond the electrode installation surface BMa. The conductor component is responsible for a part of the second circuit conductor 22 drawn out of the battery module BM and routed to the place of the battery management device BMS in the above example, and has a length corresponding to the distance from the battery module BM to the battery management device BMS.

For example, the conductor component includes a third connector physically and electrically connected to the second circuit conductor 22, a fourth connector connector—connected to the third connector, and a third circuit conductor physically and electrically connected to the fourth connector and the second connector 32. The third circuit conductor transmits and receives a signal to and from the second circuit conductor 22 via the third connector and the fourth connector, and transmits and receives a signal to and from the battery management device BMS via the second connector 32. The third circuit conductor may be an electric wire or may be provided on another circuit conductor component such as a flexible printed circuit board or a flexible flat cable.

As described above, the conductive module 1 of the present embodiment includes the first circuit conductor 21 that transmits the battery state information of each battery cell BC of the battery module BM to the battery monitoring device SBM, and the second circuit conductor 22 that is responsible for transmission and reception of a signal between the battery monitoring device SBM and the battery management device BMS. Then, the conductive module 1 includes the first connector 31 that transmits battery state information from the first circuit conductor 21 to the battery monitoring device SBM and transmits and receives a signal between the second circuit conductor 22 and the battery monitoring device SBM, and the second connector 32 that transmits and receives a signal between the second circuit conductor 22 and the battery management device BMS. Therefore, the battery pack BP including the conductive module 1 can narrow the installation space of the first circuit conductor 21 and the second circuit conductor 22 on the battery module BM as compared with the conventional battery pack in which the first circuit conductor and the second circuit conductor prepared as separate components are arranged at different places. Accordingly, the conductive module 1 of the present embodiment makes it possible to reduce the size of the battery module BM, and thus, it is possible to reduce the size of the battery pack BP.

As described above, the conductive module according to the present embodiment includes the first circuit conductor that transmits the battery state information of each battery cell of the battery module to the battery monitoring device, and the second circuit conductor that is responsible for transmission and reception of a signal between the battery monitoring device and the battery management device. Then, the conductive module includes a first connector that transmits the battery state information from the first circuit conductor to the battery monitoring device and transmits and receives a signal between the second circuit conductor and the battery monitoring device, and a second connector that transmits and receives a signal between the second circuit conductor and the battery management device. Therefore, the battery pack including the conductive module can narrow the installation space of the first circuit conductor and the second circuit conductor on the battery module as compared with the conventional battery pack. Accordingly, the conductive module according to the present embodiment makes it possible to reduce the size of the battery module, and thus, it is possible to reduce the size of the battery pack.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar configured to be physically and electrically connected to an electrode terminal of one or a pair of battery cells of a battery module in which a plurality of the battery cells is arranged;
a first circuit conductor configured to transmit battery state information of each of the battery cells to a battery monitoring device configured to monitor a battery state of each of the battery cells;
a second circuit conductor configured to be responsible for transmission and reception of a signal between the battery monitoring device and a battery management device configured to perform battery management control on the battery module;
a first connector configured to be connector-connected to the battery monitoring device to transmit the battery state information from the first circuit conductor to the battery monitoring device, and to transmit and receive a signal between the second circuit conductor and the battery monitoring device; and
a second connector configured to be connector-connected to the battery management device to transmit and receive a signal between the second circuit conductor and the battery management device.

2. The conductive module according to claim 1, further comprising:
a circuit conductor component provided with the first circuit conductor and the second circuit conductor, wherein
the first connector and the second connector are physically and electrically connected to the circuit conductor component.

3. The conductive module according to claim 1, further comprising:
a circuit conductor component provided with a first conductor pattern serving as the first circuit conductor and a second conductor pattern serving as the second circuit conductor, wherein
the first connector and the second connector are physically and electrically connected to the circuit conductor component.

4. The conductive module according to claim 1, wherein
the first circuit conductor is provided for each of the bus bars, and electrically connects the bus bar to the battery monitoring device.

5. The conductive module according to claim 2, wherein
the first circuit conductor is provided for each of the bus bars, and electrically connects the bus bar to the battery monitoring device.

6. The conductive module according to claim 3, wherein
the first circuit conductor is provided for each of the bus bars, and electrically connects the bus bar to the battery monitoring device.
